(19) United States
(12) Patent Application Publication
(10) Pub. No.: US 2024/0375082 A1
(43) Pub. Date: Nov. 14, 2024

(54) SILICA-PASSIVATED ARTICLE AND METHOD FOR FORMING

(71) Applicant: RESTEK CORPORATION, Bellefonte, PA (US)

(72) Inventors: Diego A. LOPEZ LOPEZ, State College, PA (US); Brian A. JONES, South Jordan, UT (US); Tapas K. PURKAIT, State College, PA (US)

(21) Appl. No.: 18/293,203

(22) PCT Filed: Jul. 22, 2022
(86) PCT No.: PCT/US2022/038021

§ 371 Date: Jan. 29, 2024

Related U.S. Application Data
(60) Provisional application No. 63/227,539, filed on Jul. 30, 2021.

(51) Int. Cl. B01J 20/283; B01J 20/32

(52) U.S. Cl. CPC B01J 20/283; B01J 20/3212; B01J 2220/4806; B01J 2220/86

(57) ABSTRACT

A silica-passivated article is disclosed, including a fluidic path, a fluidic path surface facing the fluidic path, and a conformal coating disposed on a passivated portion of the fluidic path surface between the fluidic path surface and the fluidic path such that the fluidic path is maintained remote from the passivated portion of the fluidic path surface across the conformal coating. The conformal coating is a silica-based coating, includes carbon-based moieties each covalently bound to singular silicon atoms of the silica-based coating, is substantially free of carbon-based moieties each covalently bound to more than one silicon atom of the silica-based coating, and is substantially free of layers of bulk silicon. The passivated portion of the fluidic path surface constitutes at least 67% of the fluidic path surface by surface area. A method for forming the silica-passivated article is disclosed including applying silsesquioxane to the fluidic path and curing.

### RELATED APPLICATIONS

This application claims the benefit of and priority to U.S. Provisional Patent Application No. 63/227,539, filed Jul. 30, 2021, entitled “Hybrid Coatings and Methods for Producing the Same,” which is hereby incorporated by reference in its entirety.

### FIELD OF THE INVENTION

This application is directed to silica-passivated articles and methods for forming silica-passivated articles. In particular, this application is directed to silica-passivated articles and methods for forming silica-passivated articles with a conformal coating including carbon-based moieties each covalently bound to singular silicon atoms of the silica-based coating and substantially free of layers of bulk silicon and substantially free of carbon-based moieties each covalently bound to more than one silicon atom of the silica-based coating.

### BACKGROUND OF THE INVENTION

Chromatography is a technique used to separate the components of a mixture based on the interactions between mobile and stationary phases. Liquid chromatography (“LC”) and gas chromatography (“GC”) are two of the most popular techniques used for the identification, quantification, and purification of analytes of interest. LC and GC devices typically use metal components that allow the transport of the mobile phases (liquids or gases) through the stationary phases, and all the way to the detector. Examples include solvent reservoir frits, pump components, connecting tubing, autosampler needles, column hardware, and detector components (as in the case for mass spectrometry (“MS”)). Although many analytes are inert to metal surfaces, others may bind to active sites on metal surfaces or to leached ions from the metal surfaces in the fluidic path. This phenomenon is commonly known as non-specific adsorption (“NSA”) or non-specific binding (“NSB”) and has significant repercussions on analytical workflow.

Stainless steel is the major metal component in most analytical instrumentation. Stainless steel has an isoelectric point (“pI”) or approximately 7 and is prone to metal ion leaching when exposed to certain organic solvents. These two factors are the main contributors to non-specific binding of many analytes containing carboxylic acids and phosphate groups. This effect is aggravated under low ionic strength mobile phases and low pH which are common conditions in MS analysis of certain analytes.

In liquid chromatography, a number of solutions have been used to circumvent NSA. Materials such as polyether ether ketone (“PEEK”) jacketing the walls of the column hardware and PEEK frits are commercially available. However, pressure limitations, low permeability, and solvent compatibility have limited the use of PEEK jacketing and frits. Acid passivation and mobile phase (“MP”) additives are another strategy to mitigate NSA; however, these solutions are temporary, time consuming, and may interfere with the analysis. Titanium has been used in many components due to its biocompatibility; however, titanium has been shown to leach ions into the fluidic path resulting in pitting.

A longer term solution includes industrial coatings deposited via chemical vapor deposition (“CVD”) or atomic layer deposition (“ALD”) of silane reagents. These processes, however, may require additional instrumentation, high vacuum, and high temperatures depending on the vapor pressures of the coating materials. Additionally, such coatings may lead to non-conformal layers and may be prone to bleeding.

### BRIEF DESCRIPTION OF THE INVENTION

In one exemplary embodiment, a silica-passivated article includes a fluidic path, a fluidic path surface facing the fluidic path, and a conformal coating disposed on a passivated portion of the fluidic path surface between the fluidic path surface and the fluidic path such that the fluidic path is maintained remote from the passivated portion of the fluidic path surface across the conformal coating. The conformal coating is a silica-based coating, includes carbon-based moieties each covalently bound to singular silicon atoms of the silica-based coating, is substantially free of carbon-based moieties each covalently bound to more than one silicon atom of the silica-based coating, and is substantially free of layers of bulk silicon. The passivated portion of the fluidic path surface constitutes at least 67% of the fluidic path surface by surface area.

In another exemplary embodiment, a method for forming a silica-passivated article includes applying silsesquioxane to a fluidic path surface facing a fluidic path of an article to form an intermediate coating and curing the intermediate coating to form a conformal coating disposed on a passivated portion of the fluidic path surface between the fluidic path surface and the fluidic path such that the fluidic path is maintained remote from the passivated portion of the fluidic path surface across the conformal coating. The conformal coating is a silica-based coating, includes carbon-based moieties each covalently bound to singular silicon atoms of the silica-based coating, is substantially free of carbon-based moieties each covalently bound to more than one silicon atom of the silica-based coating, and is substantially free of layers of bulk silicon. The passivated portion of the fluidic path surface constitutes at least 67% of the fluidic path surface by surface area.

### BRIEF DESCRIPTION OF THE DRAWINGS

FIG. 1 is a perspective view of a silica-passivated article, according to an embodiment of the present disclosure.

FIG. 2 is a cross-sectional view of the silica-passivated article of FIG. 1 taken along line 2-2, according to an embodiment of the present disclosure.

FIG. 3 is a cross-sectional view of frit, according to an embodiment of the present disclosure.

FIG. 4 is a cross-sectional view of a silica-passivated frit of FIG. 3, according to an embodiment of the present disclosure.

FIG. 5 is a graph of peak areas of adenosine monophosphate (“AMP”) analyte after passing through a stainless steel column comparing an uncoated frit, a medronic acid passivated frit, and a silica-passivated frit according to an embodiment of the present disclosure.

FIGS. 6A-C compare chromatograms of AMP passing over an uncoated frit (FIG. 6A), a frit passivated with medronic acid (FIG. 6B), and a silica-passivated frit according to an embodiment of the present disclosure (FIG. 6C).

FIG. 7 compares the Energy Dispersive Spectroscopy (“EDS”) results of uncoated frits and coated frits according to various embodiments of the present disclosure.

FIG. 8 presents a scanning electron microscope (“SEM”) backscattering image of an uncoated 2 μm frit as manufactured.

FIG. 9 presents an SEM backscattering image of a coated 2 μm frit according to an embodiment of the present disclosure.

FIG. 10 compares ¹H nuclear magnetic resonance (“NMR”) spectra of different percentages of organic moiety in methylsilsesquioxane hybrid prepolymers.

FIG. 11 presents pore analysis via incremental mercury intrusion versus pore size of a 2.1 mm i.d. Stainless steel 316 2 μm frit.

FIG. 12 presents a typical sample saturation curve on an untreated 4.6 mm i.d. stainless steel 316 frit using hydrocortisone phosphate and dexamethasone phosphate as the analytes.

FIG. 13 presents the recovery of the analytes hydrocortisone phosphate and dexamethasone phosphate on a silica-passivated 4.6 mm i.d. stainless steel 316 frit (using 50 mol % alkylsilsesquioxane and 50 mol % hydrogen silsesquioxane), according to an embodiment of the present disclosure.

FIG. 14 compares the incremental recovery of the nucleotide adenosine triphosphate from an untreated analytical column, an analytical column with a single coated frit, an analytical column with two coated frits, and an analytical column with two frits and tubing according to embodiments of the present disclosure. Columns dimensions were 50×2.1 mm i.d. and the coating agent was 50 mol % alkylsilsesquioxane and 50 mol % hydrogen silsesquioxane.

FIG. 15 depicts Diffuse Reflectance Infrared Fourier Transform Spectroscopy (“DRIFTS”) of the bulk coating polymer before curing (“prepolymer”) and after curing at 275° C. under different atmospheres: vacuum, air/vacuum, and air.

Wherever possible, the same reference numbers will be used throughout the drawings to represent the same parts.

### DETAILED DESCRIPTION OF THE INVENTION

In comparison to articles and methods lacking at least one of the features described herein, the articles and methods of the present embodiments decrease non-specific adsorption by a wide range of analytes onto metal surfaces, decrease chemical or physical interactions between fluids and fluidic channels, facilitate the recovery of analytes of interest during analytical measurement (e.g., chromatography, electrochemistry, spectroscopy, spectrometry), increase the sensitivity of analytical instruments, increase recovery of analytes, increase the duration of passivation, or combinations thereof.

Certain embodiments of the present disclosure address, among other things, the problem of non-specific adsorption by a wide range of analytes on to metal surfaces within the fluidic flow path and channels of many analytical instruments. Embodiments of the present disclosure may also alleviate chemical or physical interactions between the fluid and the channels. Chemical interactions may include, but are not limited to, leaching, corrosion, adsorption, chelation, or other chemical changes to the fluid composition while in contact with the fluidic flow path. Physical interactions may include, but are not limited to, frictional heating, fluidic turbulence, or pressure changes along the fluidic flow path.

Instruments and equipment commonly found in analytical laboratories having fluidic channels include, but are not limited to, LC analyzers, GC analyzers, MS instruments, pumps, aerators, mixers, degassers, microfluidic device components, sample collection containers and devices, sample preparation and extraction instruments, compressed gas cylinders, metal surface components. Many of these instruments and equipment have complex architectures with narrow cavities and/or porous systems. Embodiments of the present disclosure may also mitigate pitting. In certain embodiments of the present disclosure, the silica-passivated surface is considered bioinert and biocompatible with many analyses and routine applications performed in the laboratory.

Embodiments of the present disclosure may facilitate the recovery of analytes of interest that have gone through the process of analytical measurement from the very first analysis, measurement, injection, or iteration, while increasing the sensitivity of the analytical tool. Embodiments of the present disclosure may promote complete recovery of the analytes and surpasses the effect of one or more combinations of temporary recovery solutions such as acid passivation (e.g., medronic acid or citric acid), sample passivation, chelating additives (e.g., EDTA or medronic acid), and other industrial-derived coatings. The component may be permanently passivated.

“Micropore,” as used herein, refers to a pore having a diameter of less than 10 nm.

“Frit,” as used herein, refers to a fused porous metallic substrate. Frits may serve as diffusers, restrictors, capping components at the opening of a channel, or combinations thereof. Frits are labeled based on the size of particulate the frit may trap. By way of example, a 2 μm frit traps particles down to 2 μm, but the pore size of the 2 μm frit is not in actuality 2 μm. Experimentation shows that a commercially available 2 μm frit actually has an average pore size of approximately 10 μm.

“Conformal coating,” as used herein, refers to a coating which follows the contours of the substrate upon which it is disposed. In one embodiment, the conformal coating may contour to the features of the substrate when the features are greater than 10 nm in size.

“Substantially free,” as used herein, indicates less than 2% by weight.

“Bulk silicon,” as used herein, refers to both crystalline bulk silicon (also referred to as metallic silicon) and amorphous bulk silicon.

“Silica,” as used herein, encompasses both ordinary crystalline or amorphous silica as well as structurally modified silicas (also referred to as hybrid coatings or hybrid silicas) in which a first proportion of the silicon atoms of the silica are covalently bonded to four oxygen atoms and a second proportion of the silicon atoms of the silica are covalently bonded to three oxygen atoms and a fourth substituent which is either hydrogen or a carbon-based moiety. In such a manner, silicas which are structurally modified have a disrupted silica network with hydrogen and/or carbon-based moieties covalently bonded to silicon and distributed throughout. The carbon-based moieties may be any suitable functional groups, such as, but not limited to, alkyl groups, alkoxy groups, phenyl groups, benzyl groups, aromatic hydrocarbons groups, ionizable groups, tertiary groups, quaternary groups, aromatic amine groups, sulfate groups, phosphate groups, carboxylate groups, or combinations thereof. Silicas which are structurally modified by may be derived from silsesquioxanes.

“Silica-based coating,” as used herein indicates that the coating includes at least one of ordinary crystalline silica, ordinary amorphous silica, or structurally modified silicas in which a first proportion of the silicon atoms of the silica are covalently bonded to four oxygen atoms and a second proportion of the silicon atoms of the silica are covalently bonded to three oxygen atoms and a fourth substituent which is either hydrogen or a carbon-based moiety.

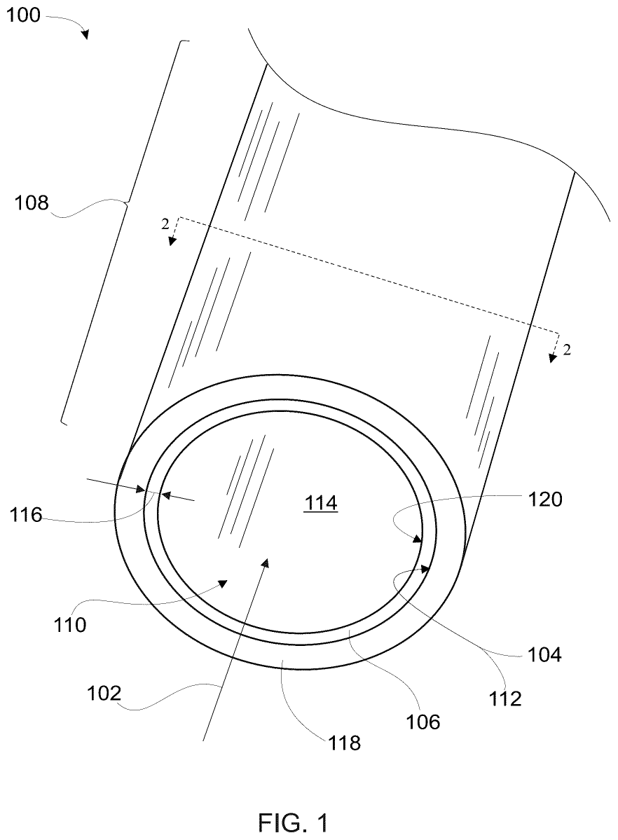

Referring to FIGS. 1, 2, and 4, in one embodiment, a silica-passivated article 100 includes a fluidic path 102, a fluidic path surface 104 facing the fluidic path 102, and a conformal coating 106 disposed on a passivated portion 108 of the fluidic path surface 104. The conformal coating 106 is disposed between the fluidic path surface 104 and the fluidic path 102 such that the fluidic path 102 is maintained remote from the passivated portion 108 of the fluidic path surface 104 across the conformal coating 106.

The conformal coating 106 is a silica-based coating. In one embodiment, the conformal coating 106 is at least 50% silica by weight, alternatively at least 55% silica by weight, alternatively at least 60% silica by weight, alternatively at least 65% silica by weight, alternatively at least 70% silica by weight, alternatively at least 75% silica by weight, alternatively at least 80% silica by weight, alternatively at least 85% silica by weight, alternatively at least 90% silica by weight, alternatively at least 95% silica by weight, alternatively at least 98% silica by weight, alternatively at least 99% silica by weight, alternatively 55-95% silica by weight, alternatively 60-90% silica by weight, or any subrange or combination thereof. Silica content of the conformal coating 106 is measured disregarding any surface modification, functionalization, or derivatizations of the silica of the silica-based coating.

The conformal coating 106 includes carbon-based moieties covalently bound to silicon atoms of the silica-based coating. Each such carbon-based moiety is bound to a single silicon atom of the silica-based coating. The carbon-based moieties may be any suitable functional groups, such as, but not limited to, alkyl groups, alkoxy groups, phenyl groups, benzyl groups, aromatic hydrocarbons groups, ionizable groups, tertiary groups, quaternary groups, aromatic amine groups, sulfate groups, phosphate groups, carboxylate groups, or combinations thereof.

The conformal coating 106 is substantially free, alternatively free, of carbon-based moieties each covalently bound to more than one silicon atom of the silica-based coating (i.e., carbon-based moieties bridging between two silicon atoms of the silica-based coating (rather than oxygen bridging the silica atoms of the silica-based coating)). In one embodiment, the conformal coating 106 has, by weight, less than 2% of carbon-based moieties each covalently bound to more than one silicon atom of the silica-based coating, alternatively less than 1.5%, alternatively less than 1%, alternatively less than 0.5%, alternatively less than 0.25%, alternatively less than 0.1%, alternatively less than 0.01%, alternatively less than 0.001%.

The conformal coating 106 is substantially free, alternatively free, of layers of bulk silicon. In one embodiment, the conformal coating 106 has, by weight, less than 2% of bulk silicon, alternatively less than 1.5%, alternatively less than 1%, alternatively less than 0.5%, alternatively less than 0.25%, alternatively less than 0.1%, alternatively less than 0.01%, alternatively less than 0.001%.

The passivated portion 108 of the fluidic path surface 104 constitutes, by surface area, at least 67% of the fluidic path surface 104, alternatively at least 75%, alternatively at least 80%, alternatively at least 85%, alternatively at least 90%, alternatively at least 95%, alternatively at least 99%, alternatively at least 99.9%. In one embodiment, the passivated portion 108 of the fluidic path surface 104 is essentially the entire fluidic path surface 104, alternatively the entire fluidic path surface 104. As used herein, “essentially the entire fluidic path surface 104” allows for de minimus imperfections in the conformal coating 106 which do not materially affect the degree of passivation and which are not detectible through non-destructive testing.

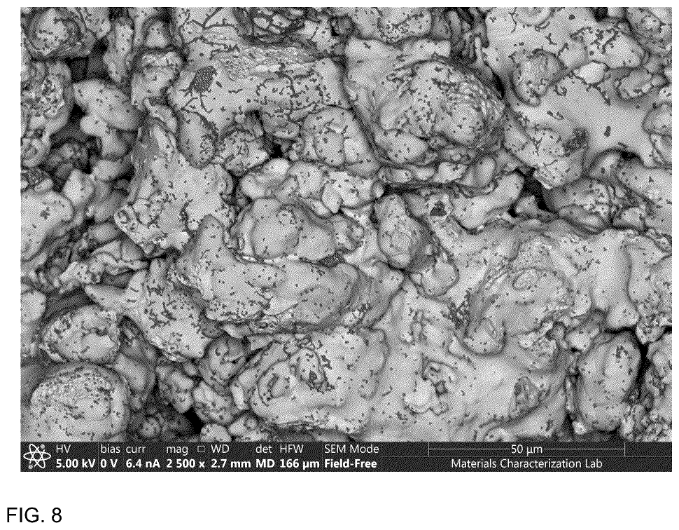

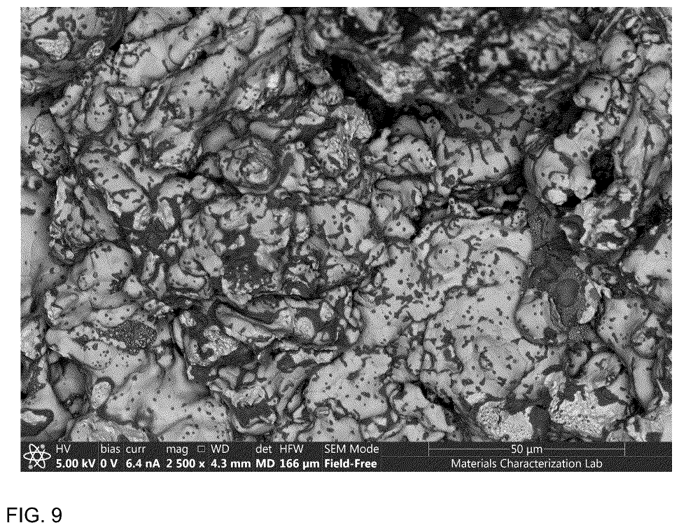

In one embodiment, at least 67% of the conformal coating 106 by surface area has a thickness varying by less than 25%, alternatively at least 75% of the conformal coating 106, alternatively at least 80% of the conformal coating 106, alternatively at least 85% of the conformal coating 106, alternatively at least 90% of the conformal coating 106, alternatively at least 95% of the conformal coating 106, alternatively at least 9% of the conformal coating 106, alternatively a thickness varying by less than 20%, alternatively a thickness varying by less than 15%, alternatively a thickness varying by less than 10%, alternatively a thickness varying by less than 5%, alternatively a thickness varying by less than 1%, or any subrange of the foregoing, or any combination of surface area and thickness of the foregoing. In certain embodiments, where the fluidic path surface 104 has significant surface roughness, stochastic porosity, or both, the conformal coating 106 remains conformal to the fluidic path surface without clogging narrow pore passages (FIG. 9 in comparison to FIG. 8; coated and uncoated components display no difference in backpressures across the components even where the article 118 is a frit).

In one embodiment, the conformal coating 106 includes a plurality of layers, each of which is a silica-based coating. In a further embodiment, each of the plurality of layers is at least 60% silica by weight. Such plurality of layers may increase the thickness of the conformal coating 106 and may provide increased lifetime and durability of the conformal coating 106 and improve pH stability.

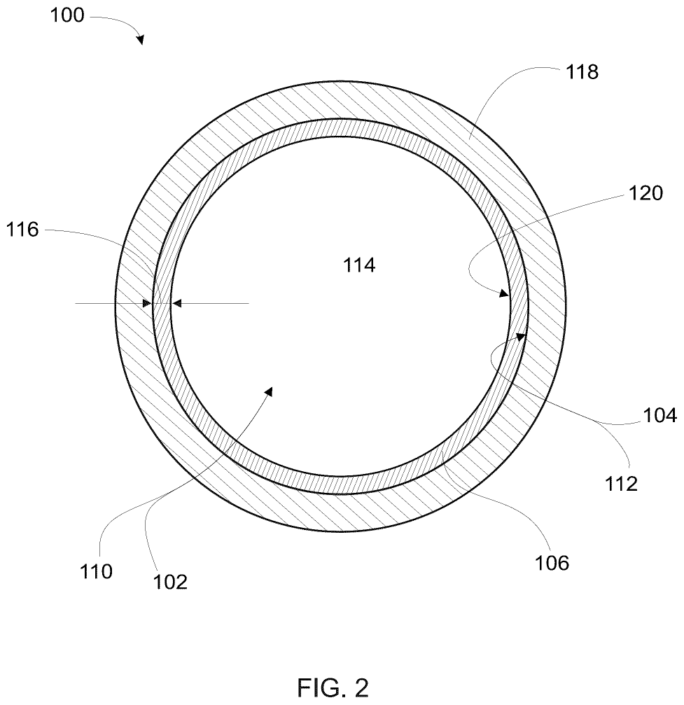

The fluidic path surface 104 may be an external surface, an internal surface, or combinations thereof of the silica-passivated article 100. Referring to FIGS. 1 and 2, in one embodiment wherein the article 118 is tubing, the fluidic path surface 104 may be an internal surface of the tubing. In another embodiment, where the article 118 is a frit, the fluidic path surface may be both an internal surface and an external surface of the frit.

The fluidic path surface 104 may include any suitable material composition, including, but not limited to, a metallic material. In one embodiment, the fluidic path surface 104 material includes a steel alloy, a stainless steel alloy, titanium, a titanium-based alloy, nickel, a nickel-based alloy, polymers, silica, an organic functionalized silica, alumina, titania, or combinations thereof.

In one embodiment, the silica-passivated article 100 includes at least one internal channel 110, the fluidic path surface 104 includes an interior surface 112 of the at least one internal channel 110, and the fluidic path 102 includes a lumen 114 defined by the interior surface 112 of the at least one internal channel 110.

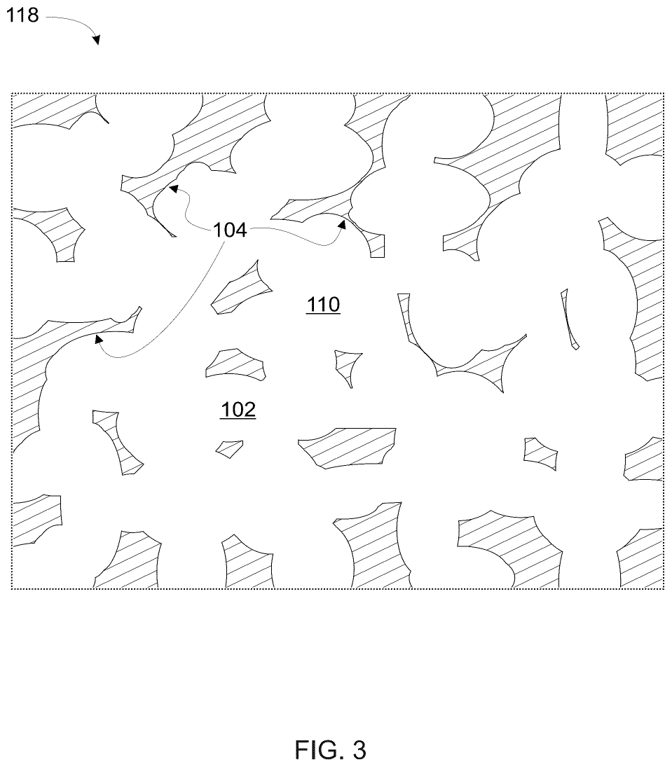

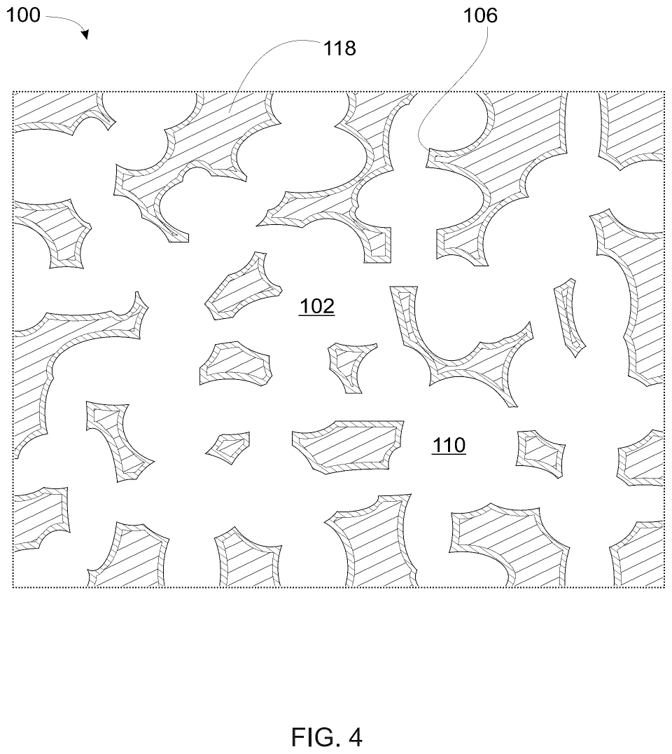

Referring to FIGS. 3 and 4, in another embodiment, the silica-passivated article 100 includes at least one porous media, the fluidic path surface 104 includes interior surfaces of the at least one porous media, and the fluidic path 102 includes pores defined by the interior surfaces of the at least one porous media. In a further embodiment, the at least one porous media includes at least one metallic frit, the interior surfaces of the at least one porous media include interior surfaces of the at least one metallic frit, and the fluidic path 102 includes pores defined by the interior surfaces of the at least one metallic frit.

The silica-passivated article 100 may be any suitable article, including, but not limited to, a gas chromatography component, a liquid chromatography component, a microfluidic device component, or combinations thereof. The article 100 may have any suitable substrate forming the fluidic path surface 104, including, but not limited to, a porous or non-porous substrate.

In one embodiment, the conformal coating 106 has an average thickness 116 from 0.1 nm to 1 μm, alternatively from 0.1 nm to 200 nm, alternatively from 100 nm to 300 nm, alternatively from 200 nm to 400 nm, alternatively from 300 nm to 500 nm, alternatively from 400 nm to 600 nm, alternatively from 500 nm to 700 nm, alternatively from 600 nm to 800 nm, alternatively from 700 nm to 900 nm, alternatively from 800 nm to 1 μm, or any suitable subrange or combination thereof.

In one embodiment, the conformal coating 106 has a surface roughness facing the fluidic path 102 less than that of the fluidic path surface 104. In one embodiment, the surface roughness facing the fluidic path 102 is at least 10% less than the surface roughness of the fluidic path surface 104, alternatively at least 15% less, alternatively at least 20% less, alternatively at least 25% less, alternatively at least 30% less, alternatively at least 35% less, alternatively at least 40% less, alternatively at least 45% less, alternatively at least 50% less.

A fluidic path facing conformal coating surface 120 of the conformal coating 106 may include micropores. Such micropores may have an average diameter of less than 10 nm, alternatively less than 5 nm, alternatively less than 2 nm, alternatively less than 1 nm, alternatively less than 0.5 nm. Micropores in the fluidic path facing conformal coating surface 120 of the conformal coating 106 may increase total pore area while decreasing average pore or lumen diameter. In one embodiment, wherein the silica-passivated article 100 is a stainless steel frit, the conformal coating has a net zero change (measured in an analysis range from 500 μm to 3 nm) in frit porosity and no measurable effect (pressure change of less than 15 psi) on pressure drop across the stainless steel frit.

In one embodiment, a method for forming a silica-passivated article 100 includes applying silsesquioxane to a fluidic path surface 104 facing a fluidic path 102 of an article 118 to form an intermediate coating. The intermediate coating is cured to form the conformal coating 106 disposed on a passivated portion 108 of the fluidic path surface 104 between the fluidic path surface 104 and the fluidic path 102 such that the fluidic path 102 is maintained remote from the passivated portion 108 of the fluidic path surface 104 across the conformal coating 106.

Curing the intermediate coating may include thermal curing, chemical curing, or combinations thereof. In one embodiment, thermal curing initiates melt reflow of the deposited intermediate coating, increasing planarization. Such planarization may improve conformance of the conformal coating 106 to the fluidic path surface 104 relative to chemical curing alone.

The silsesquioxane may be any suitable silsesquioxane or silsesquioxane derivative, including, but not limited to, hydrogen silsesquioxane, methylsilsesquioxane, ethylsilsesquioxane, propylsilsesquioxane, alkylsilsesquioxane, alkoxysilsesquioxane, phenylsilsesquioxane, benzylsilsesquioxane, aromaticsilsesquioxane, ionizable silsesquioxanes, tertiarysilsesquioxanes, quaternarysilsesquioxanes, aromatic amine silsesquioxanes, sulfate silsesquioxanes, phosphate silsesquioxanes, carboxylate silsesquioxanes, or combinations thereof (said combinations being referred to as hybrid silsesquioxanes).

In one embodiment, the silsesquioxane is a mixture of hydrogen silsesquioxane and methylsilsesquioxane in a molar ratio of 3:4 to 4:3, alternatively 4:5 to 5:4, alternatively 1:1.

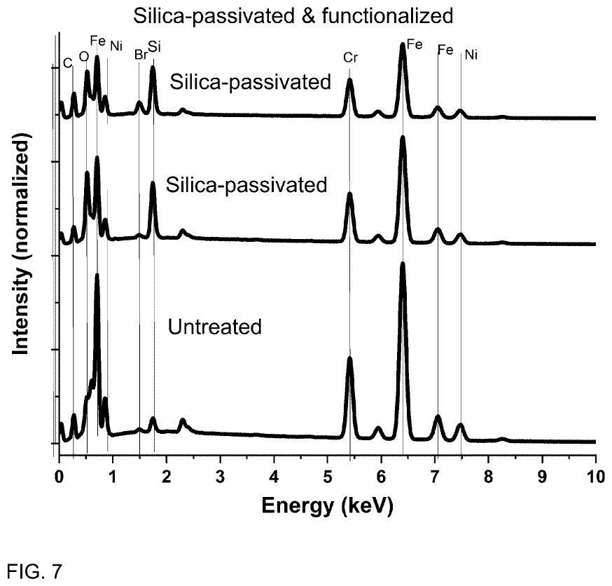

Conformal coatings 106 may be functionalized or derivatized by any suitable technique, including, but not limited to, grafting a conformal coating 106 with linkers of various lengths and functional groups, where the final product may be characterized via microscopy techniques (FIG. 7). Functionalized or derivatized conformal coatings 106 may be tuned for hydrophilicity, hydrophobicity, acid corrosion resistance, base corrosion resistance chemical inertness, temperature stability, operable pH range, chromatographic characteristics (e.g., retention factor, symmetric peak shape, increased recover), or combinations thereof. Without being bound by theory, it is believed that the grafting material (linkers) influence these properties based on their steric bulk, hydrophobicity, electrostatic attraction or repulsion, van der waal forces, added physical thickness into the conformal layer below, or combinations thereof.

In one embodiment, a fluidic path facing conformal coating surface 120 of the conformal coating 106 may be chemically functionalizing with an alkylsilane having the formula:

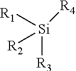

wherein R₁, R₂, and R₃ are each independently selected from the group consisting of —NH(C₁-C₆)alkyl, (C₁-C₆)alkoxy, (C₁-C₆)alkyl, (C₁-C₆)alkenyl, (C₁-C₆)alkynyl, OH, halogen, and hydrogen; and R₄ is selected from the group consisting of hydrogen, (C₁-C₂₀)alkyl, phenyl, and biphenyl.

Applying the silsesquioxane to the fluidic path surface 104 may include any suitable technique, including, but not limited to, submerging the article 118 in a solution containing the silsesquioxane and a solvent and then removing the solvent from the solution, spraying the article 118 with the solution and then removing the solvent from the solution, depositing the silsesquioxane via CVD onto the article 118, or combinations thereof.

A conformal coating 106 may be applied via submersion of the article 118 in a solution of coating reagents. Lauber et al. in U.S. Patent Application Publication No. 2019/0086371A1 has previously disclosed that liquid phase deposition of silica coatings is ineffective due to the inefficacy of the capillary action to penetrate analytical components with complex architecture. Embodiments of the present disclosure surprisingly overcome this difficulty by applying the coating reagents for a period of time such that the reagents penetrate and react with the metal surface, followed by crosslinking such reagents while in the liquid phase for a period of time or during curing, yielding a conformal coating 106. In some embodiments, the article 118 is subjected to more than one iteration of the coating step to yield a thicker and denser conformal coating 106.

Certain embodiments of the present disclosure allow for the deposition of thin films via CVD as an alternative method to LPD. Hacker in U.S. Pat. No. 6,472,076B1 highlights the low dielectric constant material derived from thin silica-derived films via CVD and their application in the semiconductor industry; however, this reference was limited to wafer materials making low dielectric materials in the semiconductor industry, and was directed to different substrates other than some of the substrates considered herein such as stainless steel. Carr et al. in U.S. Pat. No. 10,895,009B2 highlights the low dielectric constant material derived from thin silica-derived films via CVD for long narrow channels while providing strong adhesion to metal; however this reference discusses polysiloxane coatings in concert with monoatomic silicon compounds but not silsesquioxanes which are considerably different.

Hacker in U.S. Pat. No. 6,472,076B1 describes silica-derived films that have been cured in various ambient environments and temperatures, resulting in widely varying properties. Embodiments of the present disclosure utilize at least one curing processes. Ambient curing processes include curing in air, ammonia, nitrogen, argon, hydrogen, or combinations thereof. Typical curing processes proceed at temperatures of about 400° C. and for curing times of at least 30 minutes. The type of curing affects the functionality of the resulting film. Curing in air yields a predominantly Si—O film surface, whereas curing in ammonia yields a predominantly silicon oxynitride film surface and curing in inert or reducing atmospheres yields prevalently Si—H moieties at the film surface.

### EXAMPLES

### Example 1: Preparation of Alkylsilsesquioxane Hybrid Prepolymer (75 mol % Alkylsilsesquioxane-25 mol % Hydrogen Silsesquioxane)

Alkylsilsesquioxane hybrid prepolymers were prepared following a literature procedure as set forth in U.S. Pat. No. 6,218,497B1, with a modification. Alkylsilsesquioxane hybrid prepolymer with 75 mol % alkylsilsesquioxane and 25 mol % hydrogen silsesquioxane was prepared from trichlorosilane (1.0 mole equivalent) and alkyltrichlorosilane (1.0 mole equivalent). A 100 mL Morton flask, equipped with a condenser and a stir bar, was connected to a Schlenk line and purged with argon gas during the reaction through the condenser into a sodium hydroxide scrubber. 3.02 g of Amberjet 4200 ion-exchange resin catalyst (washed with methanol and dried overnight in a vacuum oven at 60° C.), 0.8 mL of methanol, and 50 mL hexanes were added to the flask, and stirring was commenced.

Trichlorosilane (1.0 equivalent, 18.0 mmol, 1.82 mL) and alkyltrichlorosilane (1.0 equivalent, 18.0 mmol) were combined together and added through a syringe pump with a rate of 0.6 mL/min. Once the addition of chlorosilanes was completed, 1.25 mL of water was added via a syringe dropwise over 1 min and the reaction mixture was stirred for another 90 min.

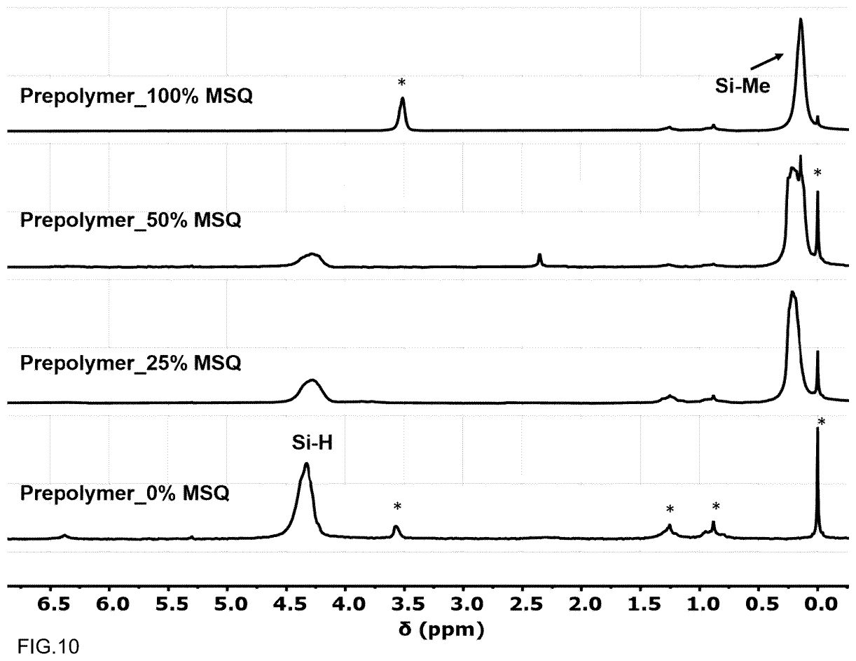

The solution was filtered by vacuum through a Whatman #4 filter paper in a Buchner funnel. The solution was transferred in a separatory funnel and the lower aqueous layer was discarded. The upper layer was dried over 3 Å molecular sieves (8.0 g) for 2.5 hours. The solution was filtered through a Whatman #4 filter paper in a Buchner funnel and concentrated using a rotary evaporator at 60° C. The crude product was dispersed in hexane and the solution was kept in a refrigerator (at 2-8° C.) overnight. The white precipitate was filtered off using a Whatman #4 filter paper in a Buchner funnel. The solution was concentrated using a rotary evaporator. The molar ratio of the Si—H group to the alkyl group was estimated from ¹H NMR spectrum (FIG. 10) and it was determined to be 1:2. The alkylsilsesquioxane hybrid polymer (1.2 g) was dispersed in dry pentane (0.24 mL) to obtain a final concentration of 20% (w/v).

### Example 2: Preparation of Alkylsilsesquioxane Hybrid Prepolymer (50 mol % Alkylsilsesquioxane-50 mol % Hydrogen Silsesquioxane)

Alkylsilsesquioxane hybrid prepolymer with 50 mol % alkylsilsesquioxane and 50 mol % hydrogen silsesquioxane was prepared from trichlorosilane (0.75 mole equivalent) and methyltrichlorosilane (0.25 mole equivalent). A 100 mL Morton flask, equipped with a condenser and a stir bar, was connected to a Schlenk line and purged with argon gas during the reaction through the condenser into a sodium hydroxide scrubber. 3.02 g of Amberjet 4200 ion-exchange resin catalyst (washed with methanol and dried overnight in a vacuum oven at 60° C.), 0.8 mL of ethanol, and 50 mL hexanes were added to the flask, and stirring was commenced.

Trichlorosilane (0.75 equivalents, 27.0 mmol, and 2.725 mL) and alkyltrichlorosilane (0.25 equivalents, 9.0 mmol) were combined together and added through a syringe pump with a rate of 0.6 mL/min. Once the addition of chlorosilanes was completed, 1.25 mL of water was added via a syringe dropwise over 1 min and the reaction mixture was stirred for another 90 minutes.

The solution was filtered by vacuum through a Whatman #4 filter paper in a Buchner funnel. The solution was transferred in a separatory funnel and the lower aqueous layer was discarded. The upper layer was dried over 3 Å molecular sieves (8.0 g) for 2.5 hours. The solution was filtered through a Whatman #4 filter paper in a Buchner funnel and concentrated using a rotary evaporator at 60° C. The crude product was dispersed in hexane and the solution was kept in a refrigerator (at 2-8° C.) for overnight. The white precipitate was filtered off using a Whatman #4 filter paper in a Buchner funnel. The solution was concentrated using a rotary evaporator. The ratio of the Si—H group to the methyl group was estimated from ¹H NMR spectrum (FIG. 10) and it was found to be 1:1. The alkylsilsesquioxane hybrid polymer was dispersed in dry pentane to obtain final concentration of 20% (w/v).

### Example 3: Coating of Metal Frits Using Alkylsilsesquioxane Hybrid Polymer

Metal frits (stainless steel, 2.1 mm i.d. with a surface area of 453 mm²) were taken either in a 20 mL scintillation vial or in a 100 mL flask and alkylsilsesquioxane hybrid (10% in 50:50 mixture of pentane/heptane) solution (the hybrid silsesquioxane prepared in Example 2, diluted down to a concentration of 10% (w/v) with heptane) was added. All the metal frits were completely immersed in the alkylsilsesquioxane solution, and the vial was shaken using a shaker at 1,200 rpm overnight. Excess solution was removed, and frits were transferred into a 50 mL Schlenk flask connected with a Schlenk line. The flask was evacuated and purged with argon gas. All the coated materials were cured overnight at 250° C. under argon gas flow.

### Functionalization of Coated Frits

Functionalizations on alkylsilsesquioxane-coated frits (prepared according to Example 3, except that 25 mol % alkylsilsesquioxane/75 mol % hydrogen silsesquioxane was used) were performed via Piers-Rubinsztajn reaction/conventional bonding strategy using 0.4 molar alkoxysilane solution in dry toluene. The coated frits were dispersed in dry toluene (5 mL). 2.0 mmol of alkoxysilane (methoxydimethyl(octadecyl)silane or (11-bromoundecyl)trimethoxysilane), followed by tris(perfluorophenyl)borane (1 mol % of alkoxysilane, 8 mg) were added. The reaction mixture was stirred for 30 min at room temperature under argon gas flow. It was heated under reflux for 16 hours under argon gas. Such functionalization altered the properties (e.g., hydrophobicity, pH stability) of the coating. Referring to FIG. 7, the first spectra shows a peak which indicates the functionalization of the polymer with (11-bromoundecyl)trimethoxysilane.

### Porosimetry Studies of Coated Frits

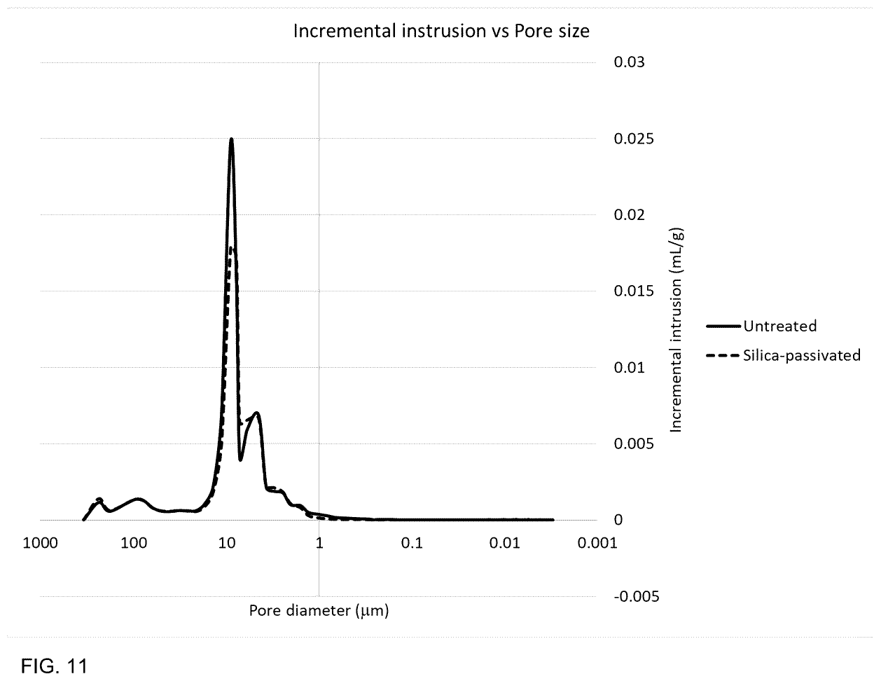

In certain embodiments, several 2.1 mm id stainless steel 316 frits were coated with a solution of 50 mol % alkylsilsesquioxane/50 mol % hydrogen silsesquioxane and cured at 275° C. for 4 hours under air atmosphere (otherwise prepared as in Examples 2 and 3). The frits were analyzed via mercury intrusion technique where an incremental intrusion vs pore size plot was generated. The conformal properties of the coating reveal a reduction of the mercury volume that is allowed inside the cavities without major shifts in pore diameters, as shown in FIG. 11.

### Performance Testing

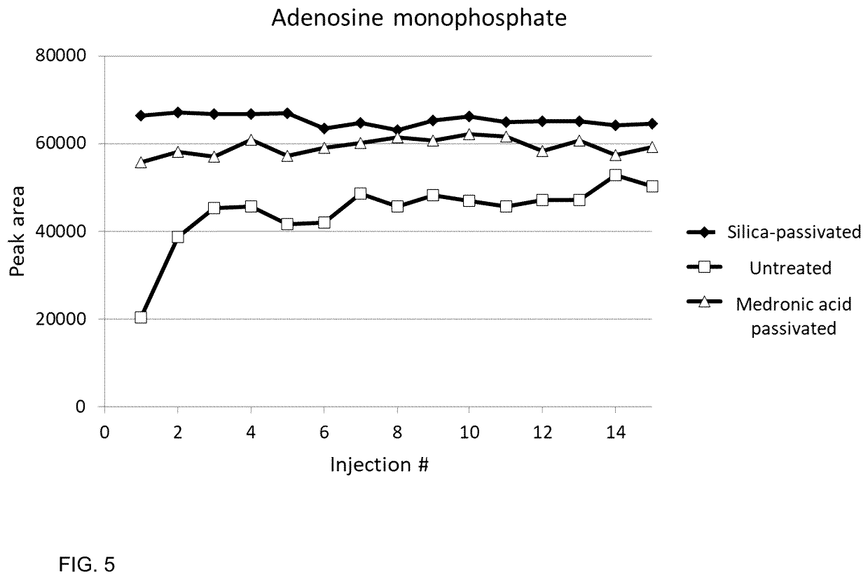

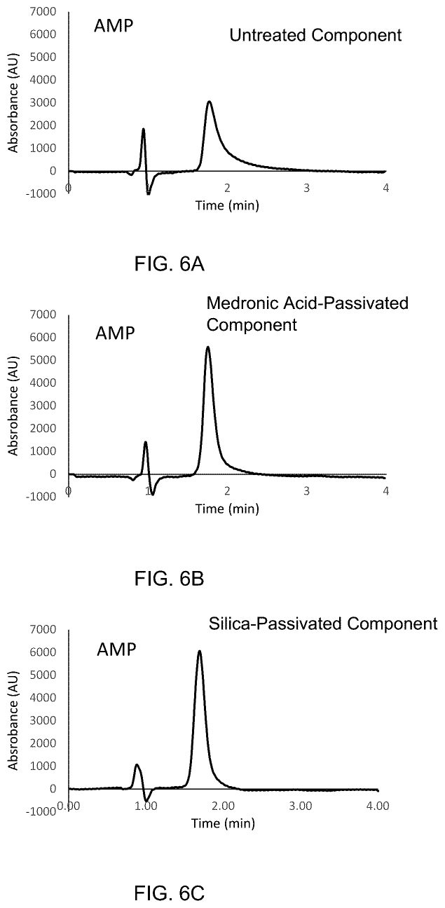

A stainless steel frit (2.1 mm i.d.) with a surface area of 453 mm² was coated by the conformal reagent as described in Example 3. The component was assayed by sampling adenosine monophosphate (“AMP”) through the component in an Agilent 1260 Infinity II UHPLC. Peak areas were plotted against 15 consecutive injections of AMP at a concentration of 50 ppm. The coated component displayed higher peak areas from the first injection when compared to otherwise identical comparative components treated with medronic acid and otherwise identical comparative untreated components (FIG. 5). The uncoated frit and the medronic acid treatment only displayed between 60-80% analyte recoveries, respectively. The untreated component required several injections in order to attain sample saturation; nevertheless, 100% recovery was not achieved with this type of analyte under the conditions tested. FIGS. 6A-C shows the chromatogram of AMP after passing through the components when untreated (FIG. 6A), treated with medronic acid (FIG. 6B), and coated with alkylsilsesquioxane (FIG. 6C). The coated component exhibited higher peak intensities, more symmetrical peaks, and less tailing when compared to the other two frits.

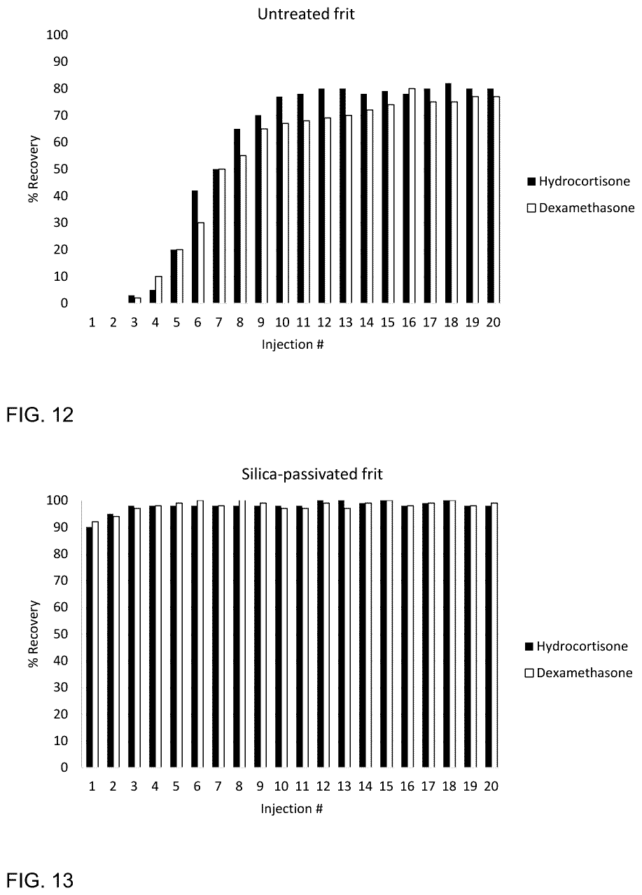

A stainless steel frit (2.1 mm i.d.) was coated by the conformal reagent as described in Example 3. The component was assayed by sampling the steroids hydrocortisone phosphate and dexamethasone phosphate at a concentration of 500 ppb and using a Shimadzu 8045 triple quadrupole mass spectrometer detector. The recovery of the steroids when passed through the coated frit component was in the range of 90-100% (FIG. 13). An untreated frit component was subject to the same sampling and no analyte recovery was measurable within the first two injections, indicating the effect of non-specific binding within the walls of the metal frit (FIG. 12). The percent recovery increased as the analytes saturate the active sites of the metal frit; however, the signal only achieved an 80% recovery after several injections.

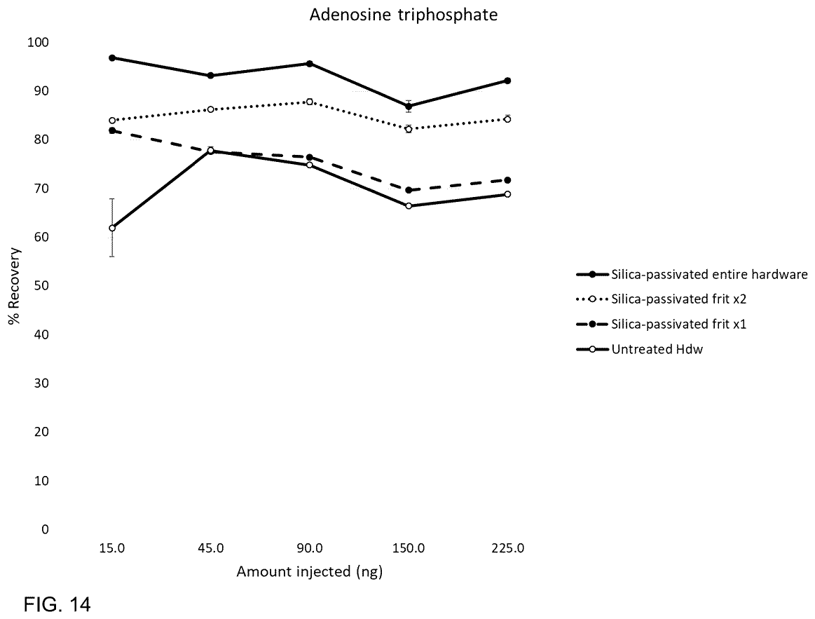

Several stainless steel column components were coated by the conformal reagent as described in Example 3. The components were assembled through different analytical columns of dimensions 50×2.1 mm i.d (FIG. 14). This demonstrated the incremental percent recovery of the nucleotide adenosine triphosphate (5 ppm) starting from an analytical column with a single coated frit, to an analytical column with both inlet and outlet frits coated, to an analytical column with a coated tubing and coated frits (inlet and outlet). The recovery of the analyte was additive as the conformal coating was applied to several components within the analytical column.

### Spectral Studies of Coated Components

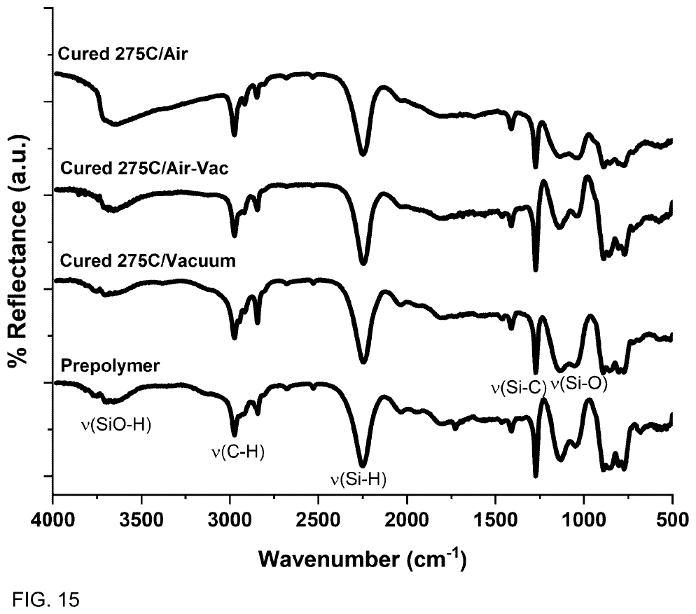

In certain embodiments, 500 mg of alkylsilsesquioxane hybrid prepolymer with 50 mol % alkylsilsesquioxane and 50 mol % hydrogen silsesquioxane were cured under the conditions listed in FIG. 15. The cured and pre-cured samples were analyzed via Infrared Spectroscopy (“IR”) with DRIFTS technique. Samples show characteristic features of the hybrid silsesquioxanes. Si—H, C—H, and SiO—H (“Silanol”) stretches and bendings are present at 2300 cm⁻¹, 2900 cm⁻¹, and 3700 cm⁻¹, accordingly. The cured polymer at 275° C. under air showed the higher degree of curing by the amount of resulting silanol while maintaining silane hydride functional groups.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A silica-passivated article, comprising:
a fluidic path;
a fluidic path surface facing the fluidic path; and
a conformal coating disposed on a passivated portion of the fluidic path surface between the fluidic path surface and the fluidic path such that the fluidic path is maintained remote from the passivated portion of the fluidic path surface across the conformal coating,
wherein:
the conformal coating is a silica-based coating;
the conformal coating includes carbon-based moieties each covalently bound to singular silicon atoms of the silica-based coating;
the conformal coating is substantially free of carbon-based moieties each covalently bound to more than one silicon atom of the silica-based coating;
the conformal coating is substantially free of layers of bulk silicon; and
the passivated portion of the fluidic path surface constitutes at least 67% of the fluidic path surface by surface area.

2. The silica-passivated article of claim 1, wherein the conformal coating is free of carbon-based moieties each covalently bound to more than one silicon atom of the silica-based coating.

3. The silica-passivated article of claim 1, wherein the conformal coating is free of layers of bulk silicon.

4. The silica-passivated article of claim 1, wherein the passivated portion of the fluidic path surface constitutes at least 90% of the fluidic path surface by surface area.

5. The silica-passivated article of claim 1, wherein at least 67% of the conformal coating by surface area has a thickness varying by less than 25%.

6. The silica-passivated article of claim 1, wherein the conformal coating includes a plurality of layers, each of which is a silica-based coating.

7. The silica-passivated article of claim 1, wherein the fluidic path surface is an internal surface of the silica-passivated article.

8. The silica-passivated article of claim 1, wherein the fluidic path surface includes a metallic material.

9. The silica-passivated article of claim 1, wherein the fluidic path surface includes a material selected from the group consisting of steel alloys, stainless steel alloys, titanium, titanium-based alloys, nickel, nickel-based alloys, polymers, silica, organic functionalized silica, alumina, titania, or combinations thereof.

10. The silica-passivated article of claim 1, wherein the silica-passivated article includes at least one internal channel, the fluidic path surface includes an interior surface of the at least one internal channel, and the fluidic path includes a lumen defined by the interior surface of the at least one internal channel.

11. The silica-passivated article of claim 1, wherein the silica-passivated article includes at least one porous media, the fluidic path surface includes interior surfaces of the at least one porous media, and the fluidic path includes pores defined by the interior surfaces of the at least one porous media.

12. The silica-passivated article of claim 11, wherein the at least one porous media includes at least one metallic frit, the interior surfaces of the at least one porous media include interior surfaces of the at least one metallic frit, and the fluidic path includes pores defined by the interior surfaces of the at least one metallic frit.

13. The silica-passivated article of claim 1, wherein the silica-passivated article is a gas chromatography component, a liquid chromatography component, a microfluidic device component, or combinations thereof.

14. The silica-passivated article of claim 1, wherein the conformal coating has an average thickness from 0.1 nm to 1 μm.

15. The silica-passivated article of claim 1, wherein the conformal coating has a surface roughness facing the fluidic path less than that of the fluidic path surface.

16. A method for forming a silica-passivated article, comprising:
applying silsesquioxane to a fluidic path surface facing a fluidic path of an article to form an intermediate coating; and
curing the intermediate coating to form a conformal coating disposed on a passivated portion of the fluidic path surface between the fluidic path surface and the fluidic path such that the fluidic path is maintained remote from the passivated portion of the fluidic path surface across the conformal coating,
wherein:
the conformal coating is a silica-based coating weight;
the conformal coating includes carbon-based moieties each covalently bound to singular silicon atoms of the silica-based coating;
the conformal coating is substantially free of carbon-based moieties each covalently bound to more than one silicon atom of the silica-based coating;
the conformal coating is substantially free of layers of bulk silicon; and
the passivated portion of the fluidic path surface constitutes at least 67% of the fluidic path surface by surface area.

17. The method of claim 16, wherein the silsesquioxane is selected from the group consisting of hydrogen silsesquioxane, methylsilsesquioxane, ethylsilsesquioxane, propylsilsesquioxane, alkylsilsesquioxane, and combinations thereof.

18. The method of claim 17, wherein the silsesquioxane is a mixture of hydrogen silsesquioxane and methylsilsesquioxane in a molar ratio of 3:4 to 4:3.

19. The method of claim 16, further including chemically functionalizing a fluidic path facing conformal coating surface with an alkylsilane having the formula: 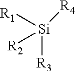
wherein R₁, R₂, and R₃ are each independently selected from the group consisting of —NH(C₁-C₆)alkyl, (C₁-C₆)alkoxy, (C₁-C₆)alkyl, (C₁-C₆)alkenyl, (C₁-C₆)alkynyl, OH, halogen, and hydrogen; and R₄ is selected from the group consisting of hydrogen, (C₁-C₂₀)alkyl, phenyl, and biphenyl.

20. The method of claim 16, wherein applying the silsesquioxane to the fluidic path surface includes:
submerging the article in a solution containing the silsesquioxane and a solvent and then removing the solvent from the solution;
spraying the article with the solution and then removing the solvent from the solution;
depositing the silsesquioxane via chemical vapor deposition onto the article; or combinations thereof.
